(19) United States
(12) Patent Application Publication
(10) Pub. No.: US 2026/0111800 A1
(43) Pub. Date: Apr. 23, 2026

(54) METHODS AND SYSTEMS FOR DISTRIBUTED AI MODEL TRAINING

(71) Applicant: Huawei Technologies Co., Ltd., Shenzhen (CN)

(72) Inventors: Weisen Shi, Ottawa (CA); Xu Li, Nepean (CA); Chenchen Yang, Ottawa (CA)

(21) Appl. No.: 19/391,896

(22) Filed: Nov. 17, 2025

Related U.S. Application Data
(63) Continuation of application No. PCT/CN2023/094938, filed on May 18, 2023.

(51) Int. Cl. G06N 20/00

(52) U.S. Cl. CPC G06N 20/00

(57) ABSTRACT

Methods and systems for training a distributed Artificial Intelligence (AI) model over a distributed network are disclosed, and where a function is configured to: in response to a convergence level of an entity meeting a first threshold, transmit a message for transferring the entity from an unfrozen to a frozen state; in response to training data volume meeting a second threshold, transmit a second message and a third message for stopping a training epoch by the entity and a non-top-level partition entity; in response to a difference between local batch and local distributions being above a third threshold, transmit a fourth message to the client for stopping of feeding training batch; and in response to a difference between the local batch and the overall distributions being above a fourth threshold, transmit a fifth message to the client for decreasing data feeding frequency of the training batch.

### CROSS-REFERENCE TO RELATED APPLICATIONS

This application is a continuation of International Application No. PCT/CN2023/094938, filed on May 18, 2023, the disclosure of which is hereby incorporated by reference in its entirety.

### TECHNICAL FIELD

The present technology relates to model training, and specifically to methods and systems for distributed AI model training.

### BACKGROUND

Massive Artificial Intelligence (AI) models with millions or billions parameters have shown great potentials in various AI applications. Broadly, massive AI models, also known as large language models, are AI systems that are capable of processing and analyzing vast amounts of data. These models are typically trained on massive amounts of text data, such as books, articles, and websites, and are designed to understand the nuances and subtleties of human language. The most well-known examples of massive AI models include GPT-3, T5, and BERT. These models are capable of generating human-like text, answering complex questions, and completing a wide range of natural language processing tasks. For that reason, massive AI models have the potential to revolutionize a wide range of industries, including healthcare, finance, and education.

However, existing massive AI models are owned and trained by tech-giants using intensive computing resources, which are too expensive to be used by comparatively smaller companies, let alone individuals. Therefore, there is a need for reducing a computational cost for training and using massive AI models.

### SUMMARY

Developers have devised methods and devices for overcoming at least some drawbacks present in prior art solutions.

Developers of the present technology have realized that, to reduce the cost of utilizing massive AI models, one approach is to split/decouple an original (massive) AI model into multiple partitions deployed in a distributed system (e.g., a network). Each entity (e.g., server, device) in the distributed system only instantiates one or multiple partitions of the original AI model whose computation load for training and/or inferencing are afforded by the corresponding entity's computing resources. The partitions of the original AI model in the distributed system form the distributed AI model.

For example, Split Learning (SL) is one technique to split an original AI model into a distributed AI model composed by an encoder and a classifier. With reference to FIG. 2A, there is depicted schematic representation of an AI model 200 comprising an encoder 202 and a classifier 204. The encoder 202 includes an input layer 206 and a hidden layer 208 after the input layer 206. The classifier 204 includes additional hidden layers 210 and the output layer 212. The encoder 202 may comprise more than one hidden layers, and the classifier 204 may comprise remaining hidden layers (if any) without departing from the scope of the present technology. The encoder 202 and the classifier 204 of can be instantiated in different computing entities (not depicted), respectively. The training data interacting between the encoder 202 and classifier 204—that is, forward/forwarding propagation (FP) data and back-propagation (BP) data—is transmitted via network connections/links.

Developers of the present technology have realized that parallelization techniques can be applied to the training of a distributed AI model. At least one parallelization technique is disclosed in an article entitled “Split learning over wireless networks: parallel design and resource management”, authored by W. Wu et al., published on Dec. 31, 2022, the content of which is incorporated herein by reference in its entirety.

With reference to FIG. 2B, a distributed AI model 220 comprises by the classifier 204 instantiated on a “server side”, and multiple copies of the encoder 202 on a “client side” (or device side). Each client has the same model structure and parameters (weights and bias on neurons and links) as that of the encoder 202. In traditional SL, the training of an SL model can only be executed sequentially among clients. To accelerate the training speed of SL, the cluster based parallel SL training can classify the clients into one or multiple clusters before training. The cluster scheme ensures that clients in the same cluster are instantiated on entities with similar computing resources. Within each cluster, all clients parallelly execute one FP and one BP as seen on FIG. 2B as steps “1” and “2”. Then, all clients synchronize the encoder parameters (e.g., by the average values of all clients'updated local parameters) as seen on FIG. 2B as steps “3”. Among clusters, the training is conducted in a sequential way—that is, the former cluster completing a parallel training iteration updates the synchronized encoder parameters to all devices in the later cluster as seen on FIG. 2B as step “4”. Then, the later cluster conducts a parallel training iteration within the cluster. The training of the SL model continues by iterating the preceding steps until the SL model converges.

Developers of the present technology have realized at least some drawbacks with conventional training methods for distributed AI models. It should be noted that conventional training control methods designed for single AI models (i.e., the AI model instantiated on a centralized entity or cloud) are directly applied to distributed AI models. One drawback of such a framework is that the training of a distributed AI model can only be controlled as an integral objective, and without fine-grained training control on partition granularity. In other words, only control/customize of training behaviors of one or multiple partition(s) is possible in such a framework, without control/customize of training behaviors of other given partitions. Developers have realized that since different partitions can be instantiated on entities with different computing capabilities (i.e., amount of available computing resources), to accelerate the convergence speed of distributed AI model training, the fine-grained training control on partition granularity which can customize the training behaviors of each partition according to computing capability of the entity instantiating the partition is desired.

Also, it should be noted that the criteria to stop a training epoch, referred to herein as “epoch stop criteria”, are pre-configured and cannot be dynamically customized within each epoch. However, for distributed AI model deployed over a network, any bottleneck partition that is instantiated on the entity with scarce computing capability or unstable network connections (e.g., wireless links) can cause significant training delay for the whole epoch. Developers of the present technology have realized that to reduce the overall training delay caused by the bottleneck partition, the dynamic epoch stop control, which can actively stop each epoch without waiting the bottleneck partitions while ensure the overall training performance, is desired.

In at least some aspects of the present technology, developers have devised methods and systems for distributed AI model training which can conduct fine-grained training control on partition granularity, and dynamic epoch stop control for each epoch.

More specifically, in accordance with a first broad aspect of the present technology, there is provided a method of training a distributed AI model. The distributed AI model comprises a plurality of partitions. The plurality of partitions is instantiated over a distributed network. The method comprises, during a given training iteration of the distributed AI model: acquiring, by a DATC function executed over the distributed network, one or more messages from one or more entities in the distributed network, each entity instantiating a copy of a partition of the distributed AI model, the one or more messages being indicative of one or more convergence levels of the copy of the partition, each convergence level corresponds to a respective one from the one or more entities; comparing, by the DATC function, the one or more convergence levels against a pre-determined threshold; and in response to a first convergence level of a first entity from the one or more convergence levels meeting the pre-determined threshold, transmitting, by the DATC function, a second message to the first entity for transferring the copy of the partition of the first entity from an unfrozen state to a frozen state.

In some implementations of the method, in response to all of the one or more convergence levels meeting the pre-determined threshold, transmitting, by the DATC function, a second message to each of the one or more entities for transferring the respective copies of the partition from an unfrozen state to a frozen state.

In some implementations of the method, the first message is further indicative of a current state of the copy of the partition, the current state being the unfrozen state.

In some implementations of the method, the copy of the partition in the unfrozen state is configured to perform forward propagation and backward propagation.

In some implementations of the method, the partition in the frozen state is configured to perform only forward propagation.

In some implementations of the method, the method further comprises: at another moment in time during training of the distributed mode: acquiring, by the DATC function, a third message from a second entity in the distributed network amongst the one or more entities, the third message being indicative of a second convergence level; comparing, by the DATC function, the first convergence level against the second convergence level; and in response to the first convergence level being within a pre-determined interval from the second convergence level, transmitting, by the DATC function, a fourth message to the first entity, the fourth message being indicative of transferring the frozen state of the copy of the partition of the first entity to the unfrozen state.

Further, in accordance with a second broad aspect of the present technology, there is provided a method of training a distributed AI model. The distributed AI model comprises a plurality of partitions. The plurality of partitions is instantiated over a distributed network. The method comprises, during a given training epoch of the distributed AI model: acquiring, by a DATC function executed over the distributed network, a first message from a first entity in the distributed network, the first entity instantiating a top-level partition of the distributed AI model in the distributed network, the first message being indicative of training data volume processed by the first entity during a previous training iteration; comparing, by the DATC function, the training data volume against a pre-determined threshold; in response to the training data volume meeting the pre-determined threshold, transmitting, by the DATC function, a second message to the first entity and a third message to a second entity in the distributed network, the second entity instantiating a non-top-level partition of the distributed network, the second message and the third message for stopping of the given training epoch by the first entity and the second entity.

Further, in accordance with a third broad aspect of the present technology, there is provided a method of training a distributed AI model. The distributed AI model comprises a plurality of partitions. The plurality of partitions is instantiated over a distributed network. The method comprises, during a current training iteration: acquiring, by a DATC function executed over the distributed network, local batch distribution information from a client of the distributed network, the local batch distribution information is indicative of data distribution of a training batch used in for the current training iteration; comparing, by the DATC function, the local batch distribution information against a local data distribution information of the client and an overall data distribution information, the local data distribution information being indicative of a distribution of a local training data set of the client, the overall data distribution information being indicative of overall data distribution of training data sets used to train the distributed AI model; in response to a difference between the local batch distribution and the local distribution being above a pre-determined threshold, transmitting, by the DATC function, a first message to the client for stopping feeding the training batch; and in response to a difference between the local batch distribution and the overall distribution being above another pre-determined threshold, transmitting, by the DATC function, a second message to the client for decreasing data feeding frequency of the training batch during the current training iteration and following training iterations.

In some implementations of the method, the method further comprises, prior to the current training iteration: acquiring, by the DATC function executed over the distributed network, the local data distribution information from the client; and determining, by the DATC function, the overall data distribution information based on the local data distribution information.

In some implementations of the method, the method further comprises: determining, by the DATC function, the local data distribution information and the overall data distribution information using a history of local batch distribution information acquired from the client.

Further, in accordance with a fourth broad aspect of the present technology, there is provided a system for training a distributed AI model. The distributed AI model comprises a plurality of partitions. The plurality of partitions is instantiated over a distributed network. The system comprises: (i) a processor communicatively coupled to the distributed network and configured to execute a DATC function over the distributed network; and (ii) a non-transitory computer-readable memory storing instructions. The processor, upon executing the instructions, is configured to: during a given training iteration of the distributed AI model: acquire one or more messages from one or more entities in the distributed network, each entity instantiating a copy of a partition of the distributed AI model, the one or more messages being indicative of one or more convergence levels of the copy of the partition, each convergence level corresponds to a respective one from the one or more entities; compare the one or more convergence levels against a pre-determined threshold; and in response to a first convergence level of a first entity from the one or more convergence levels meeting the pre-determined threshold, transmit a second message to the first entity for transferring the copy of the partition of the first entity from an unfrozen state to a frozen state.

In some implementations of the system, in response to all of the one or more convergence levels meeting the pre-determined threshold, the processor is further configured to transmit a second message to each of the one or more entities for transferring the respective copies of the partition from an unfrozen state to a frozen state.

In some implementations of the system, the first message is further indicative of a current state of the copy of the partition, the current state being the unfrozen state.

In some implementations of the system, the copy of the partition in the unfrozen state is configured to perform forward propagation and backward propagation.

In some implementations of the system, the partition in the frozen state is configured to perform only forward propagation.

In some implementations of the system, the processor is further configured to: at another moment in time during training of the distributed mode: acquire a third message from a second entity in the distributed network amongst the one or more entities, the third message being indicative of a second convergence level; compare the first convergence level against the second convergence level; and in response to the first convergence level being within a pre-determined interval from the second convergence level, transmit a fourth message to the first entity, the fourth message being indicative of transferring the frozen state of the copy of the partition of the first entity to the unfrozen state.

Further, in accordance with a fifth broad aspect of the present technology, there is provided a system for training a distributed AI model. The distributed AI model comprises a plurality of partitions. The plurality of partitions is instantiated over a distributed network. The system comprises: (i) a processor communicatively coupled to the distributed network and configured to execute a DATC function over the distributed network; and (ii) a non-transitory computer-readable memory storing instructions. The processor, upon executing the instructions, is configured to: during a given training epoch of the distributed AI model: acquire a first message from a first entity in the distributed network, the first entity instantiating a top-level partition of the distributed AI model in the distributed network, the first message being indicative of training data volume processed by the first entity during a previous training iteration; compare the training data volume against a pre-determined threshold; in response to the training data volume meeting the pre-determined threshold, transmit a second message to the first entity and a third message to a second entity in the distributed network, the second entity instantiating a non-top-level partition of the distributed network, the second message and the third message for stopping of the given training epoch by the first entity and the second entity.

Further, in accordance with a sixth broad aspect of the present technology, there is provided a system for training a distributed AI model. The distributed AI model comprises a plurality of partitions. The plurality of partitions is instantiated over a distributed network. The system comprises: (i) a processor communicatively coupled to the distributed network and configured to execute a DATC function over the distributed network; and (ii) a non-transitory computer-readable memory storing instructions. The processor, upon executing the instructions, is configured to: during a current training iteration: acquire local batch distribution information from a client of the distributed network, the local batch distribution information is indicative of data distribution of a training batch used in for the current training iteration; compare the local batch distribution information against a local data distribution information of the client and an overall data distribution information, the local data distribution information being indicative of a distribution of a local training data set of the client, the overall data distribution information being indicative of overall data distribution of training data sets used to train the distributed AI model; in response to a difference between the local batch distribution and the local distribution being above a pre-determined threshold, transmitting, by the DATC function, a first message to the client for stopping feeding the training batch; and in response to a difference between the local batch distribution and the overall distribution being above another pre-determined threshold, transmitting, by the DATC function, a second message to the client for decreasing data feeding frequency of the training batch during the current training iteration and following training iterations.

In some implementations of the system, prior to the current training iteration, the processor is further configured to: acquire the local data distribution information from the client; and determine the overall data distribution information based on the local data distribution information.

In some implementations of the system, the processor is further configured to: determine the local data distribution information and the overall data distribution information using a history of local batch distribution information acquired from the client.

In the context of the present specification, a “server” is a computer program that is running on appropriate hardware and is capable of receiving requests (e.g., from devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “device” is any computer hardware that is capable of running software appropriate to the relevant task at hand. Thus, some (non-limiting) examples of devices include personal computers (desktops, laptops, netbooks, etc.), smartphones, and tablets, as well as network equipment such as routers, switches, and gateways. It should be noted that a device acting as a device in the present context is not precluded from acting as a server to other devices. The use of the expression “a device” does not preclude multiple devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers. It can be said that a database is a logically ordered collection of structured data kept electronically in a computer system.

In the context of the present specification, the expression “information” includes information of any nature or kind whatsoever capable of being stored in a database. Thus information includes, but is not limited to audiovisual works (images, movies, sound records, presentations etc.), data (location data, numerical data, etc.), text (opinions, comments, questions, messages, etc.), documents, spreadsheets, lists of words, etc.

In the context of the present specification, the expression “component” is meant to include software (appropriate to a particular hardware context) that is both necessary and sufficient to achieve the specific function(s) being referenced.

In the context of the present specification, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 illustrates an example of a computing device that may be used to implement any of the methods described herein

FIG. 2A illustrates a schematic representation of an AI model comprising an encoder and a classifier.

FIG. 2B illustrates a conventional Split Learning (SL) training procedure.

FIG. 3A illustrates a schematic representation of a distributed AI model comprising partitions on a client side and on a server side.

FIG. 3B illustrates an augmented tree structure of the distributed AI mode in a distributed network.

FIG. 4 depicts an automated partition freezing/de-freezing method provided by a DATC function, in accordance with at least some non-limiting embodiments of the present technology.

FIG. 5 illustrates an active epoch stop control method provided by the DATC function in FIG. 4, in accordance with at least some non-limiting embodiments of the present technology.

FIG. 6 illustrates an automated data distribution balancing method provided by the DATC function in FIG. 4, in accordance with at least some non-limiting embodiments of the present technology.

FIG. 7 is a schematic illustration of a distributed network, in accordance with at least some non-limiting embodiments of the present technology.

### DETAILED DESCRIPTION OF THE ILLUSTRATIVE EMBODIMENTS

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some embodiments of the present technology, the processor may be a general purpose processor, such as a central processing unit (CPU) or a processor dedicated to a specific purpose, such as a digital signal processor (DSP). Moreover, explicit use of the term a “processor” should not be construed to refer exclusively to hardware capable of executing software, and may implicitly include, without limitation, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown. Moreover, it should be understood that module may include for example, but without being limitative, computer program logic, computer program instructions, software, stack, firmware, hardware circuitry or a combination thereof which provides the required capabilities.

With these fundamentals in place, we will now consider some non-limiting examples to illustrate various implementations of aspects of the present technology.

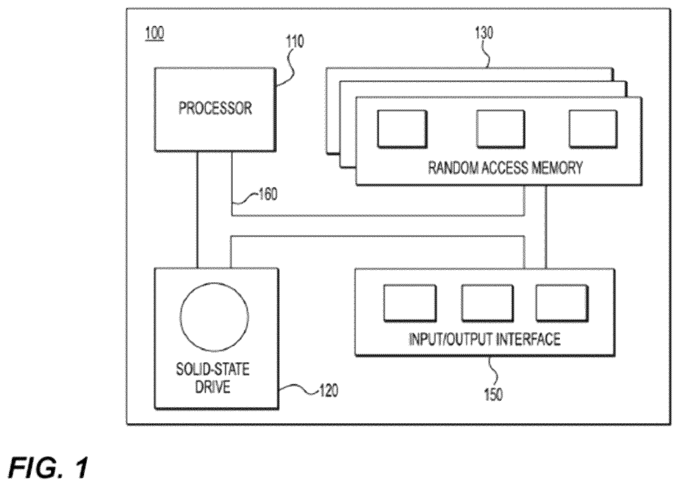

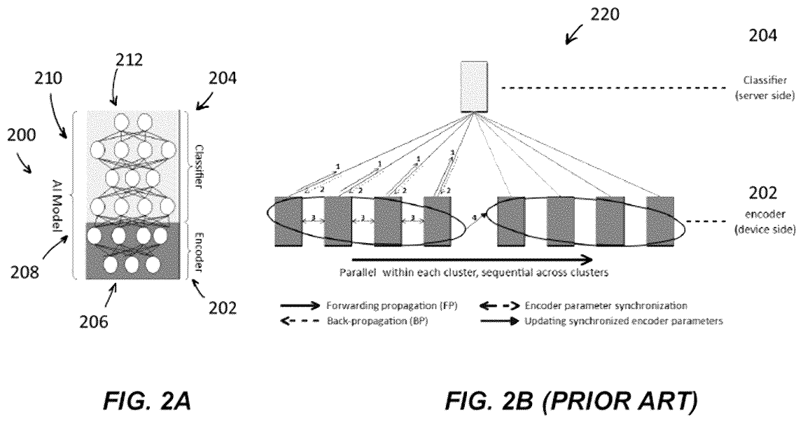

FIG. 1 illustrates a diagram of a computing environment 100 in accordance with an embodiment of the present technology is shown. In some embodiments, the computing environment 100 may be implemented by any of a conventional personal computer, a computer dedicated to operating and/or monitoring systems relating to a data center, a controller and/or an electronic device (such as, but not limited to, a mobile device, a tablet device, a server, a controller unit, a control device, a monitoring device etc.) and/or any combination thereof appropriate to the relevant task at hand. In some embodiments, the computing environment 100 comprises various hardware components including one or more single or multi-core processors collectively represented by a processor 110, a solid-state drive 120, a random access memory 130 and an input/output interface 150.

In some embodiments, the computing environment 100 may also be a sub-system of one of the above-listed systems. In some other embodiments, the computing environment 100 may be an “off the shelf” generic computer system. In some embodiments, the computing environment 100 may also be distributed amongst multiple systems. The computing environment 100 may also be specifically dedicated to the implementation of the present technology. As a person in the art of the present technology may appreciate, multiple variations as to how the computing environment 100 is implemented may be envisioned without departing from the scope of the present technology.

Communication between the various components of the computing environment 100 may be enabled by one or more internal and/or external buses 160 (e.g. a PCI bus, universal serial bus, IEEE 1394 “Firewire” bus, SCSI bus, Serial-ATA bus, ARINC bus, etc.), to which the various hardware components are electronically coupled.

The input/output interface 150 may allow enabling networking capabilities such as wire or wireless access. As an example, the input/output interface 150 may comprise a networking interface such as, but not limited to, a network port, a network socket, a network interface controller and the like. Multiple examples of how the networking interface may be implemented will become apparent to the person skilled in the art of the present technology. For example, but without being limitative, the networking interface may implement specific physical layer and data link layer standard such as Ethernet, Fibre Channel, Wi-Fi or Token Ring. The specific physical layer and the data link layer may provide a base for a full network protocol stack, allowing communication among small groups of computers on the same local area network (LAN) and large-scale network communications through routable protocols, such as Internet Protocol (IP).

According to implementations of the present technology, the solid-state drive 120 stores program instructions suitable for being loaded into the random access memory 130 and executed by the processor 110 for executing operating data centers based on a generated machine learning pipeline. For example, the program instructions may be part of a library or an application.

In some embodiments of the present technology, the computing environment 100 may be implemented as part of a cloud computing environment. Broadly, a cloud computing environment is a type of computing that relies on a network of remote servers hosted on the internet, for example, to store, manage, and process data, rather than a local server or personal computer. This type of computing allows users to access data and applications from remote locations, and provides a scalable, flexible, and cost-effective solution for data storage and computing. Cloud computing environments can be divided into three main categories: Infrastructure as a Service (IaaS), Platform as a Service (PaaS), and Software as a Service (SaaS). In an IaaS environment, users can rent virtual servers, storage, and other computing resources from a third-party provider, for example. In a PaaS environment, users have access to a platform for developing, running, and managing applications without having to manage the underlying infrastructure. In a SaaS environment, users can access pre-built software applications that are hosted by a third-party provider, for example. In summary, cloud computing environments offer a range of benefits, including cost savings, scalability, increased agility, and the ability to quickly deploy and manage applications.

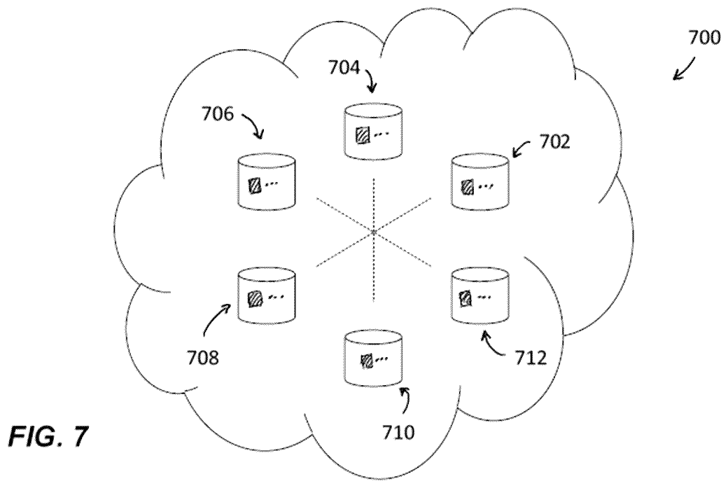

In other embodiments of the present technology, the computing environment 100 may be implemented as part of a distributed network 700 seen in FIG. 7. The distributed network 700 comprises entities 702-712, each of which may be implemented similarly to the computing environment 100. Broadly, a distributed network is a type of computer network where data, processing, and communication tasks are shared among multiple interconnected nodes or computers, rather than being centralized on a single server or computer. In a distributed network, each node is responsible for performing a specific task, and communication between nodes is usually done through message passing. Distributed networks can be used in a variety of applications, including file sharing, content delivery, and peer-to-peer networking, and AI model training. In summary, distributed networks offer several benefits, such as increased scalability, improved fault tolerance, and better performance.

In some embodiments, the distributed network 700 may be a public distributed network. In other embodiments, the distributed network 700 may be a private distributed network. As it will become apparent from the description herein further below, a given client and/or a given user of a distributed AI model may be part of, or external to, the distributed network 700, without departing from the scope of the present technology. It can be said that the distributed network 700 may host training data for training a distributed AI model, and/or may receive training data from an entity communicatively coupled to the distributed network 700. It can be said that the distributed network 700 may use predictions of the distributed AI model to an entity that is communicatively coupled to the distributed network 700 and/or to an entity that is part of the distributed network 700.

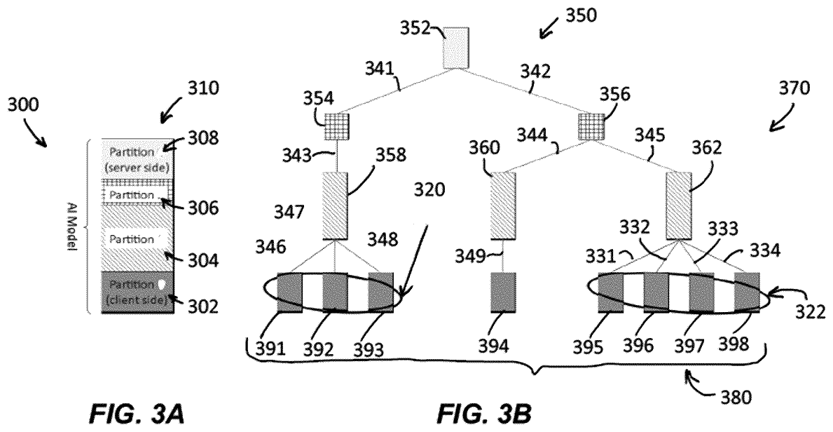

In at least some embodiments of the present technology, with reference to FIG. 3A there is depicted a distributed AI model 300. The distributed AI model 300 is split into a plurality of partitions 310. A bottom-level partition 302 comprises an input layer. Optionally, the bottom-level partition 302 may further comprise one or more hidden layers after the input layer of an original AI model. A top-level partition 308 comprises an output layer. Optionally, the top-level partition 308 further comprises one or more hidden layers before the output layer of the original AI model. Other partition which is not a top-level partition is referred to as non-top-level partition.

Intermediate partitions 304 and 306 between the partition 302 and the partition 308 respectively comprise one or multiple hidden layers of the original AI model. In accordance with a FP direction, for each partition, an adjacent partition before a given partition is referred to as a “preceding” partition, while the adjacent partition after the given partition is referred to as a “following” partition. For example, the partition 302 is a preceding partition to the partition 304, while the partition 306 is a following partition to the partition 304. It should be noted that a layer splitting a partition with a following partition is referred to as a “cutting” layer and is contained in the partition as the output layer thereof (e.g., last layer in a given partition in accordance with FP).

Broadly, a given distributed AI model is composed by the partitions of an original AI model instantiated in a distributed system (e.g., the distributed network 700 of computing devices). To enable parallel training, each partition of the original AI model can have one or multiple copies in the distributed AI model. The different copies of a partition have a same model structure and can be instantiated on different entities in the distributed network 700. Each copy of a partition of the original AI model contained in the distributed AI model is referred to herein as a distributed “AI model node”, or “node”for short.

Without being bound to any specific theory, the distributed AI model 300 can be expressed as a hierarchical augmented tree model 350 illustrated in FIG. 3B. Each level of the augmented tree structure of the hierarchical augmented tree model 350 corresponds to a partition of the original AI model, and each distributed AI model node in that level represents a copy of the partition of the original AI model.

In the augmented tree structure, a root node 354 represents a copy of the top-level partition 308. A given leaf node from a plurality of leaf nodes 380 represents a copy of the bottom-level partition 302. In this example, leaf nodes 391 to 398 represent copies of the bottom-level partition 302. A given branch node from a plurality of branch nodes 370 represents a copy of the partition corresponding to the level of that branch node. In this example, branch nodes 354 and 356 are copies of the intermediate partition 306. In this example, branch nodes 358, 360, and 362 are copies of the intermediate partition 304. Edges 341 to 349 and edges 331 to 334 in the augmented tree structure 350 represent the FP/BP data flow transmissions between respective copies of partitions during the training/inferencing of the distributed AI model 300.

In some embodiments, a given entity in the distributed network 700 (e.g., server, device) can instantiate one or multiple distributed AI model node(s) according to the computing capability of that entity. In other embodiments, a given distributed AI model node can be instantiated by one or multiple entities in the distributed network 700. A given entity in the distributed network 700 may be implemented in a similar manner to the computer environment 100 described above, and without departing from the scope of the present technology.

It should be noted that in some embodiments, the partition 308 can be instantiated at “server side” controlled by a third-party (outside of the distributed network 700). In these embodiments, it can be said that a preceding partition of the partition 308 may be referred to as a “top-level partition” in the distributed network 700.

It should be noted that in further embodiments, the plurality of leaf nodes 380 (i.e., copies of partition 302) can be instantiated at “client side” where multiple clients are classified into one or multiple cluster(s). For example, the plurality of leaf nodes 380 comprises a first cluster 320 comprising the leaf nodes 391, 392 and 393, a second cluster 322 comprising the leaf nodes 395, 396, 397, and 398, and the non-clustered leaf node 394.

It is contemplated that leaf nodes instantiated on the clients within a same cluster have a same parent node in the augmented tree structure 350. In this example, the leaf nodes 391, 392, 393, and 394 have the same parent/following node 358. In this example, the leaf nodes 395, 396, 397, and 398 have the same parent/following node 362. The edges 341 to 349 and the edges 331 to 334 in the augmented tree structure 350 are instantiated by physical connections/links (wired or wireless) in the distributed network 700.

In at least some embodiments of the present technology, the computer environment 100 may be configured to control training of a distributed AI model 300. To that end, the computer environment 100 may be configured to execute a Distributed AI Training Control (DATC) function for performing dynamically control of the training of the distributed AI model 300. It is contemplated that the DATC function 404 may be executable by a given entity of the distributed network 700. In other embodiments, one or more functionalities of the DATC function 404 may be implemented in a distributed manner over more than one entity of the distributed network 700, without departing from the scope of the present technology.

Broadly speaking, the DATC function 404 is a logic controller which can be instantiated in either centralized way (e.g., over a Cloud, on a server, on an electronic device) and/or on the distributed network 700 entities. In some embodiments, the DATC function 404 can be instantiated as the internal functionality of a network control module/function, for example, a service control function (SCF) in NET4AI. Broadly, NET4AI is a service-oriented architecture for 6G wireless systems which provides E2E support to AI applications, from deployment phase to operation phase. The NET4AI architecture is generally described in an article entitled “Nine Challenges in Artificial Intelligence and Wireless Communications for 6G”, authored by Wen Tong and Geoffry Ye Li, published in 2021, the contents of which is incorporated herein by reference in its entirety.

In some embodiments of the present technology, it is contemplated that the DATC function 404 may be used for performing training control methods to accelerate the training of distributed AI model. At least two training control methods provided by the DATC function will now be briefly discussed.

A first training control method comprises automated partition freezing/de-freezing. The DATC function 404 may be used to monitor the convergence status of respective distributed AI model nodes (copies of the original AI model partition). If the convergence status meets certain criteria (pre-known or learnt, for example), the DATC function 404 may be used to freeze and/or de-freeze the gradient updating of a given distributed AI model node to accelerate the overall convergence speed.

Broadly, during each training iteration, the state of a distributed AI model node can be either “unfrozen” state or “frozen” state. In unfrozen state (or normal state), the distributed AI model node (a.k.a., unfrozen node) conducts FP and BP (which includes updating the weights and bias of all neurons/links in that node). While in frozen state, the distributed AI model node (a.k.a., frozen node) conducts FP, but does not update/change the weights and bias of all neurons/links in the node in the BP. Therefore, during each iteration, a distributed AI model node in frozen state is not impacted/updated by the input data and back-propagated gradients of the corresponding iteration. A “control” action to transfer a distributed AI model node from unfrozen state to frozen state is referred to herein as “freezing” the node. A “control” action to transfer a distributed AI model node from frozen state to unfrozen state is referred to herein as “de-freezing”the node.

A second training control method comprises active epoch stop control. The DATC function 404 may be used to monitor trained data volume in each training epoch. If the trained data volume is sufficient (e.g., meets the pre-determined criteria), DATC function 404 may be used to stop the current training epoch to save training time. It is contemplated that the active epoch stop control can prevent significant delay caused by bottleneck nodes in a given distributed AI model.

As it will become apparent from the description herein further below, to employ one or more training control methods provided by the DATC function 404, a “user” can send a distributed AI model training request to the DATC function 404. It is contemplated that the “user” can be either a network-internal functionality (e.g., a task control function of NET4AI service), or a third-party application. It is contemplated that the distributed AI model training request includes (i) information of a target distributed AI model including, but not limited to, IDs of nodes in the distributed AI model 300, model parameters of each node (e.g., weights and bias of neurons/links) in the distributed AI model 300, topology of the distributed AI model 300 (e.g., the hierarchical augmented tree 350), location(s)/address(es) of the entity/entities instating respective nodes in the distributed AI model 300, and (ii) requested training control method(s).

It should be noted that a “user” refers to an entity that is to use outputs of the distributed AI model, while a “client” refers to an entity that provides data to the AI model during training and/or inference. In one example, the client may be an electronic device such as a smartphone, for example. In another example, the client may be a sensor communicatively coupled to the distributed network 700. In a further example, a user may be an application layer associated with the distributed network 700.

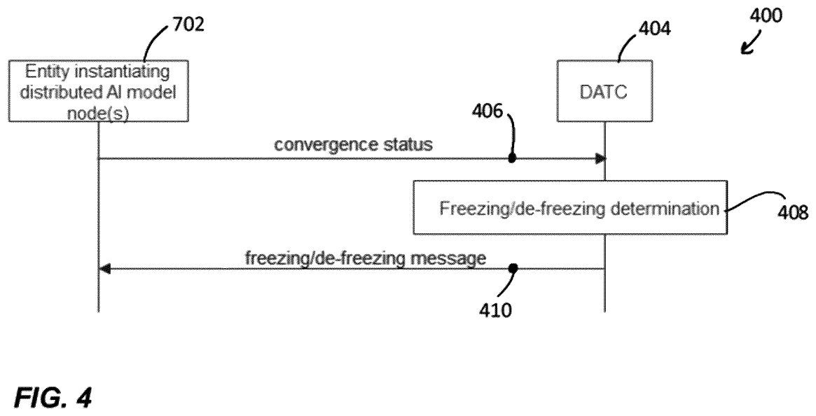

With reference to FIG. 4, there is depicted a representation 400 of an automated partition freezing/de-freezing method executable in accordance with some embodiments of the present technology. In FIG. 4, there is depicted the entity 702 instantiating one or more distributed AI model nodes. As mentioned above, the DATC function may be instantiated by one or more entities (same or different as the entity 702) of the distributed network 700.

It is contemplated that the automated partition freezing/de-freezing method may be periodically executed by the DATC function 404 during the training phase of the distributed AI model. In one example, the automated partition freezing/de-freezing method may be triggered a plurality of times during a given training epoch of the distributed AI model.

The automated partition freezing/de-freezing method begins at step 406 with the entity 702 transmitting to the DATC function 404 a convergence status indication at the end of a given iteration. It is contemplated that at the end of each iteration, each entity instantiating distributed AI model node(s) may send information indicative of a “convergence status” of respective nodes instantiated on the corresponding entities to the DATC function 404. It is contemplated that each convergence status may correspond to one distributed AI node.

For example, let it be assumed that the partition 358 is instantiated on the entity 702. In this example, the entity 702 is configured to transmit the convergence status of the partition 358 to the DATC function 404. In another example, let it be assumed that the partitions 360 and 362 are instantiated on a given entity. In this example, the given entity may transmit a convergence status of the partition 360 and/or a convergence status of the partition 362.

In some embodiments of the present technology, information indicative of the convergence status may comprise (i) a state of the node in a past iteration such as a frozen state and/or an unfrozen state, for example; (ii) a convergence level of the corresponding instantiated node (copy of the original AI model partition). The convergence level can be defined as a value to quantify how close (i) current weights and bias of neurons/links in the node to (ii) converged weights and bias of neurons/links in the corresponding node. In one non-limiting example, a variation of weights and bias of neurons/links in the node between two adjacent iterations may be indicative of the convergence level of the node.

The automated partition freezing/de-freezing method continues to step 408 with the DATC function 404 configured to execute an operation on the received convergence status. It is contemplated that after receiving the convergence status of each node sent by corresponding entities, the DATC function 404 compares the received convergence status of each node with a corresponding “convergence criteria” to trigger an action. For example, based on the comparison the DATC function 404 may be configured to determine whether to freeze or to de-freeze a given node. The convergence criteria are pre-determined by an operation and/or pre-trained by the DATC function 404. Alternatively, or additionally, the convergence criteria may be provided by the user. In one non-limiting example, the convergence criteria (applied to respective nodes) may be indicative of a threshold value of convergence level. The threshold value may be computed by the historical convergence records.

Developers of the present technology have realized that the DATC function 404 may be configured to determine the freezing/de-freezing decision in a variety of ways. In some embodiments, the DATC function 404 may be configured to perform “independent freezing”. In these embodiments, by the end of a current iteration, the DATC function 404 can freeze a distributed AI model node if its convergence level meets one or more freezing criteria. In these embodiments, by the end of any future iteration, if the convergence level gap between the frozen node and other unfrozen nodes having the same structure as the frozen node (i.e., the frozen and unfrozen nodes which are copies of the same partition of the original AI model) exceeds a pre-defined threshold, the DATC function 404 de-freezes the frozen node. For example, let it be assumed that the convergence status of the partition 358 has been received by the DATC function 404 and the DATC function 404 determines to freeze the partition 358. If, at a future iteration, a convergence gap between the partition 360 and currently frozen partition 358 is above a pre-defined threshold, the partition 358 can be unfrozen by the DATC function 404 for further convergence.

In other embodiments of the present technology, the DATC function 404 may be configured to perform “comparison-based freezing”. In these other embodiments, by the end of each iteration, the DATC function 404 may compare the convergence levels of all nodes in a partition set. It should be noted that a partition set comprises all nodes that are copies of a same partition of the original AI model—that is, a corresponding partition of the partition set. In these other embodiments, if a mean and variation values of the convergence level of nodes in a partition set reach pre-defined thresholds, all nodes in the partition set may be identified as converged and can be frozen by the DATC function 404. For example, the partitions 358, 360 and 362 may be monitored based on their convergence statuses. If the convergence levels of the partitions 358, 360 and 362 reach pre-defined thresholds, all three partitions 358, 360, and 362 can be frozen by the DATC function.

The automated partition freezing/de-freezing method continues to step 410 with the DATC function 404 transmitting to the entity 702 an indication to freeze and/or de-freeze the node 702. For example, if the DATC function 404 determines to freeze a node, DATC function 404 is configured to send a “freezing” message to the entity 702 instantiating the node. Entity/entities receiving the freezing message(s) may be configured to transfer the node into frozen state. If the DATC function 404 determines to de-freeze a node, DATC function 404 is configured to send a “de-freezing” message to the entity 702 instantiating the node. Entity/entities receiving the de-freezing message(s) may be configured to transfer the node into unfrozen state.

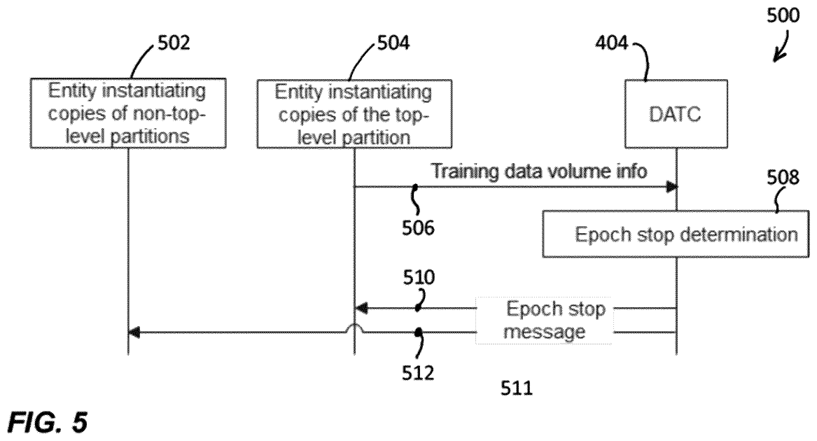

With reference to FIG. 5, there is depicted a representation 500 of an “active epoch stop control” method executable in accordance with some embodiments of the present technology. In FIG. 5, there is depicted the entity 704, and entity 706, and the DATC function implemented on the distributed network 700. It is contemplated that the DATC function 404 may be configured to execute the active epoch stop control method during and/or after respective training iterations of the distributed AI model. For example, during each training iteration of a given epoch, the DATC function 404 may trigger execution of one or more steps of the active epoch stop control method. the DATC function 404.

The active epoch stop control method begins at step 506 with the entity 706 (instantiating a given copy of the corresponding top-level partition in the distributed network) sending to the DATC function 404 an indication comprising training data volume information. For example, the entity instantiating the partition 352 may send the indication indicative of training data volume information to the DATC function 404.

It is contemplated that during a given training epoch, each entity instantiating copies of the top-level partition periodically can send the training data volume info to the DATC function 404. The training data volume information includes the volume (i.e., quantity of data sample) of trained data processed on the corresponding entity (by one or more copies of the top-level partition instantiated on the entity) in previous iteration. The trained data is defined as training data which has been used in a preceding training iteration.

In those embodiments where more than one copy of the top-level partition is instantiated by respective entities in the distributed network 700, each respective entity instantiating a given copy of the top-level partition is configured to send the training data volume info to the DATC function 404, without departing from the scope of the present technology.

The active epoch stop control method continues to step 508 with the DATC function 404 monitoring the received training data volume information, and/or calculating the accumulated trained data volume (e.g., summation of volumes of trained data in all received training data volume information). If the trained data volume meets an epoch stop criteria, the DATC function 404 determines to stop the current training epoch. The epoch stop criteria can be pre-defined in the DATC function 404, and/or provided by the user.

It is contemplated that the epoch stop criteria may be configured so as to ensure that the accumulated trained data volume is sufficient—that is, does not result in negative impacts to the final training performance of the distributed AI model, when the epoch stop criteria is met. In some embodiments, the epoch stop criteria can be a threshold of (total accumulated trained data volume/total training data volume). The total training data volume can be pre-knowledge provided by the user, or obtained by enumerating the whole dataset in first epoch without applying active epoch stop control. In some embodiments, the DATC function 404 can only determine to stop the training epoch which executing time exceeds a pre-defined epoch execution time threshold, without departing from the scope of the present technology.

The active epoch stop control method continues to step 511 with the DATC function 404 configured to transmit epoch stop messages 510 and 512 to the entity 706 and 704, respectively, if the DATC function 404 determines to stop the current training epoch. It is contemplated that the DATC function 404 may be configured to transmit an epoch stop message to one or more entities instantiating nodes of the distributed AI model 300, if the DATC function 404 determines to stop the current training epoch. Each entity receiving the epoch stop message stops the current training epoch executed on node(s) instantiated on the entity.

Developers of the present technology have realized that known solutions without active epoch stop control method have to train on all the training data in each epoch. The distributed AI model node(s) that suffer from limited computing resources and/or from limited communication resources may cause an increase in epoch training time. The active epoch stop control method may be employed by the DATC function 404 so that the training of each epoch is no longer “delayed” by delayed training data from node(s) suffering from resource scarcity. This may result in comparatively shorter epoch training times. For example, if data is delayed over the link 348, using the active epoch stop control, the DATC function 404 may stop a current training epoch of the distributed AI model without using the delayed data from the link 348.

Developers of the present technology have realized that when applying the active epoch stop control method, the training data processed by distributed AI model node(s) suffering computing or communication resource scarcity may be discarded in high probabilities, and therefore, the volume of accumulated trained data impacting the distributed AI model 300 training performance is smaller than the volume of total training data. In some embodiments of the present technology, to prevent the set of accumulated trained data having a distribution bias, an automated data distribution balancing control method may be optionally executed in combination with the active epoch stop control method by the DATC function 404, without departing from the scope of the present technology.

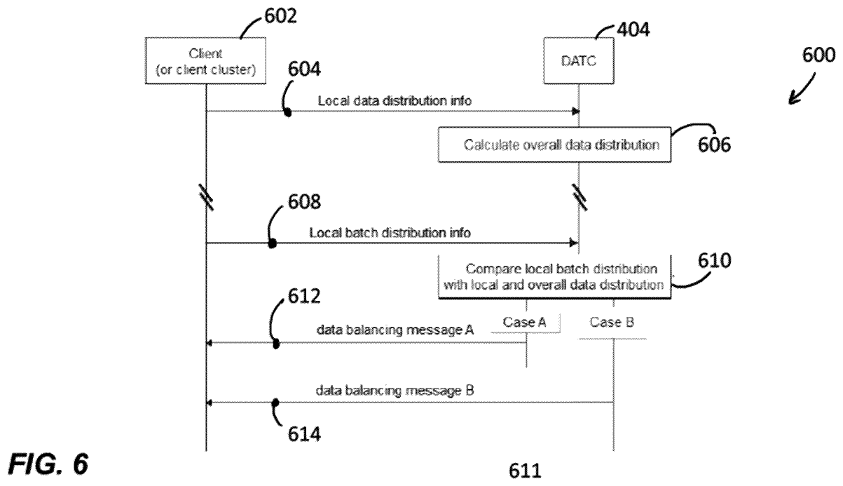

With reference to FIG. 6, there is illustrated a representation 600 of an automated data distribution balancing control method performed by the DATC function 404 in accordance with non-limiting embodiments of the present technology. At step 604, a client 602 (or a client cluster such as for example, one or more entities instantiating the cluster 320) may send local data distribution information to the DATC function 404. Prior to the training, each client (cluster) may send its local data distribution info to the DATC function 404. For example, the DATC function 404 may receive a first message from an entity hosting the cluster 320, a second message from the entity hosting the copy 394, and a third message from an entity hosting the cluster 322.

The local data distribution info is indicative of the data distribution of the local training data set associated with the client 602. It is contemplated that the information about contents of the training data may not be required to be transmitted. At step 606, after receiving local data distribution information sent by the client 602 and/or other clients (clusters), the DATC function 404 is configured to compute an overall data distribution of all training data sets according to the received local data distribution information.

At step 608, prior to executing a given training iteration, the client 602 and/or other clients send local batch distribution information to the DATC function 404. The local batch distribution information is indicative of data distribution of the training batch used in the training iteration. The contents of the training data in the batch may not be required to be transmitted.

At step 610, after receiving local batch distribution information sent by the client 602, the DATC function 404 is configured to compare the local batch distribution with the local data distribution of the client 602 and the overall data distribution to determine a “data distribution balancing”decision.

In some embodiments, it is contemplated that the steps 604 and 606 can be performed before the training of the distributed AI model begins. In further embodiments, it is contemplated that the step 608 may be performed an/or repeated upon provision of a corresponding batch of data samples by the client 602.

At step 611, the DATC function 404 may be configured to send a data balancing message to the client 602. In some cases, if the DATC function 404 determines that the local batch distribution of the client 602 varies over a pre-determined threshold than the local data distribution of the client 602, the DATC function 404 sends data balancing message 612 to the client (cluster). Developers have realized that if the DATC function 404 determines that the local batch distribution of the client 602 varies over a pre-determined threshold than the local data distribution of the client 602, the training data in the batch may be contaminated. The client 602 receiving data balancing message 612 stops feeding the training batch to the client 602 in the iteration.

In other cases, if DATC function 404 determines that the local batch distribution of the client 602 varies over a pre-determined threshold than the overall data distribution, the DATC function sends data balancing message 614 to the client 602. Developers have realized that if DATC function 404 determines that the local batch distribution of the client 602 varies over a pre-determined threshold than the overall data distribution, the distribution of training data in the batch may have bias which can negatively impact the distributed AI model 300 training performance. The client 602 receiving data balancing message 614 decreases the data feeding/sample frequency of the client 602 in current and following iterations, which may reduce the negative impacts caused by the bias data to the distributed AI model training 300 performance. Optionally, the new data feeding frequency can be included in the data balancing message 614.

In some embodiments, the client 602 may have no access to the associated local data distribution (e.g., real-time data collection). In these embodiments, the steps 604 and 606 can be omitted for the client 602, and the local data distribution information can be gradually obtained by the DATC function 404 in accordance with multiple rounds of local batch distribution information received via iterations of the step 608.

In some embodiments, the DATC function 404 may receive a plurality of local batch distribution infos over time, similarly to how the DATC function 404 receive the local batch distribution info at step 608. The DATC function 404 may be configured to use this history of local batch distribution to calculate overall data distribution. As previously alluded to, the DATC function 404 may then be configured execute the step 610 based on a latest local batch distribution and the so-calculated overall data distribution.

In some aspects of the present technology, the DATC function 404 may be configured to dynamically freezing/de-freezing the training of distributed AI model node(s) (copies of partitions of the original AI model) in order to (i) accelerate the convergence speed of a given distributed AI model by freezing well-trained node(s), and/or (ii) saving computing resource consumption by bypassing BP processing in frozen node(s).

In other aspects of the present technology, the DATC function 404 may be configured to dynamically control the stop of each training epoch during distributed AI model training, and automatedly balancing the distribution of training data feeding to each client (cluster). The DATC function 404 may perform dynamic control of a stop of training epochs for (i) accelerating the convergence speed by discarding training data processed by bottleneck node(s), and/or prevent the set of accumulated trained data having distribution bias by automated data distribution balancing.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

What is claimed is:

1. A method comprising:
during a given training iteration of a distributed Artificial Intelligence (AI) model, the distributed AI model comprising a plurality of partitions, the plurality of partitions instantiated over a distributed network, performing the following:
acquiring, by a Distributed AI Training Control (DATC) function executed over the distributed network, one or more messages from one or more entities in the distributed network, each entity of the one or more entities instantiating a copy of a partition of the plurality of partitions of the distributed AI model, the one or more messages being indicative of one or more convergence levels of the copy of the partition, and each convergence level corresponding to a respective one from the one or more entities;
comparing, by the DATC function, the one or more convergence levels against a pre-determined threshold; and
in response to a first convergence level of a first entity from the one or more convergence levels meeting the pre-determined threshold, transmitting, by the DATC function, a second message to the first entity for transferring the copy of the partition of the first entity from an unfrozen state to a frozen state.

2. The method of claim 1, wherein in response to all of the one or more convergence levels meeting the pre-determined threshold, transmitting, by the DATC function, a second message to each of the one or more entities for transferring the respective copies of the partition from an unfrozen state to a frozen state.

3. The method of claim 1, wherein the one or more messages are further indicative of a current state of the copy of the partition, the current state being the unfrozen state.

4. The method of claim 1, wherein the copy of the partition in the unfrozen state is configured to perform forward propagation and backward propagation.

5. The method of claim 1, wherein each partition, while in the frozen state, is configured to perform only forward propagation.

6. The method of claim 1, further comprising:
at another moment in time during training of the distributed mode:
acquiring, by the DATC function, a third message from a second entity in the distributed network amongst the one or more entities, the third message being indicative of a second convergence level;
comparing, by the DATC function, the first convergence level against the second convergence level; and
in response to the first convergence level being within a pre-determined interval from the second convergence level, transmitting, by the DATC function, a fourth message to the first entity, the fourth message being indicative of transferring the frozen state of the copy of the partition of the first entity to the unfrozen state.

7. A method comprising:
during a given training epoch of a distributed Artificial Intelligence (AI) model, the distributed AI model comprising a plurality of partitions, and the plurality of partitions instantiated over a distributed network, performing the following:
acquiring, by a Distributed AI Training Control (DATC) function executed over the distributed network, a first message from a first entity in the distributed network, the first entity instantiating a top-level partition of the distributed AI model in the distributed network, the first message being indicative of training data volume processed by the first entity during a previous training iteration;
comparing, by the DATC function, the training data volume against a pre-determined threshold;
in response to the training data volume meeting the pre-determined threshold, transmitting, by the DATC function, a second message to the first entity and a third message to a second entity in the distributed network, the second entity instantiating a non-top-level partition of the distributed network, the second message and the third message being for stopping of the given training epoch by the first entity and the second entity.

8. A method comprising:
during a current training iteration of a distributed Artificial Intelligence (AI) model, the distributed AI model comprising a plurality of partitions, the plurality of partitions being instantiated over a distributed network, performing the following:
acquiring, by a Distributed AI Training Control (DATC) function executed over the distributed network, local batch distribution information from a client of the distributed network, the local batch distribution information being indicative of data distribution of a training batch used in for the current training iteration;
comparing, by the DATC function, the local batch distribution information against a local data distribution information of the client and an overall data distribution information, the local data distribution information being indicative of a distribution of a local training data set of the client, the overall data distribution information being indicative of overall data distribution of training data sets used to train the distributed AI model;
in response to a difference between the local batch distribution and the local distribution being above a pre-determined threshold, transmitting, by the DATC function, a first message to the client for stopping of feeding the training batch; and
in response to a difference between the local batch distribution and the overall distribution being above another pre-determined threshold, transmitting, by the DATC function, a second message to the client for decreasing data feeding frequency of the training batch during the current training iteration and following training iterations.

9. The method of claim 8, further comprising:
prior to the current training iteration, acquiring, by the DATC function executed over the distributed network, the local data distribution information from the client; and
determining, by the DATC function, the overall data distribution information based on the local data distribution information.

10. The method of claim 8, further comprising:
determining, by the DATC function, the local data distribution information and the overall data distribution information using a history of local batch distribution information acquired from the client.
